(19) United States
(12) Patent Application Publication
(10) Pub. No.: US 2017/0291045 A1
(43) Pub. Date: Oct. 12, 2017

(54) DISCHARGER STRUCTURE ON EARLOOP FACE MASKS

(71) Applicant: MTJ TECHNOLOGY CO., LTD., Taoyuan City (TW)

(72) Inventor: JEN-WEI LIN, TAOYUAN CITY (TW)

(21) Appl. No.: 15/446,377

(22) Filed: Mar. 1, 2017

(30) Foreign Application Priority Data
Apr. 6, 2016 (TW) 105204686

(51) Int. Cl. A62B 9/02; A62B 18/08; A62B 18/02

(52) U.S. Cl. CPC A62B 9/02; A62B 18/02; A62B 18/084

(57) ABSTRACT

A discharger structure on earloop facemasks includes at least one opening hole on an earloop facemask covered by a cover. The cover is in a streamline shape and has a passage space for airflow. A check valve is disposed in the opening hole at an inner side of the cover, and the cover further has a discharging hole at an opposite side of the check valve, defining an area within the passage space between the check valve and the discharging hole for airflow. Thereby the check valve is closed by a diaphragm when air pressure within the facemask is negative, and the check valve is opened by the diaphragm when air pressure within the facemask is positive, so as to control airflow through the check valve.

### BACKGROUND OF THE INVENTION

### 1. Field of the Invention

The present invention relates to a discharger structure on earloop facemasks, particularly to one that includes a passage space for one-way discharge of breathed air.

### 2. Description of the Related Art

Atmospheric particulate matters are commonly known to be harmful to human health. They are substances exiting in the atmosphere in microscopic level. As technologies developed, particulate matters have become a serious issue due to its increasing density in the atmosphere, which endangers human health in many ways. To prevent from the harms and diseases particulate matters may cause, facemasks are important and useful for keeping the particulate matters from being inhaled into human body.

N95 respirators and facemasks are manufactured to help block out potential contaminants and filter particles in the environment. However, researches and experiments have proven that normal facemasks cannot block out and filter small particles with a diameter of 2.5 g m or less. Also, they are designed to be used for a single time but not durable in practical use. N95 respirators and facemasks in similar designs are therefore used for better filter and blocking out, but they may cause difficult breathing to wearers after a period in use. Consequently, there have been discharger structures to be installed or disposed on such respirators and facemasks for easier breathing. Nonetheless, such discharger structures are heavy and conspicuously large in volume, and sometimes they cannot function properly due to interference of pressure differences between inside and outside the respirators and facemasks.

### SUMMARY OF THE INVENTION

A primary object of the present invention is to provide a discharger structure to be disposed on earloop facemasks that has a diaphragm closing an area to ensure less contact to outside air and thereby decrease possibilities of contamination by polluted air.

Another object of the present invention is to provide a discharger structure that is rotatable on earloop facemasks so that it can block out potential contaminants in the rains and in the air and discharge breathed air smoothly.

Yet another object of the present invention is to provide a discharger structure that applies the Bernoulli's principle to discharge breathed air from within earloop facemasks efficiently.

To achieve the objects mentioned above, the present invention comprises an earloop facemask having a least one opening hole at a position near nostrils of human faces when worn on and at least one discharger structure. The discharger structure includes a cover arranged in a streamline shape covering said opening hole from outside, said cover including a passage space therein; a check valve disposed on said opening hole, said check valve including a body protruding from said opening hole into said passage space and a diaphragm disposed on a top periphery of said body and partially fixed thereon; a discharging hole arranged on said cover at an opposite end from said check valve, defining an area in said passage space between said check valve and said discharging hole; and a rotation structure engaged on said check valve for said cover to rotate thereby.

Whereby the check valve is closed by the diaphragm when air pressure within said earloop facemask is negative, preventing from airflow therein, and whereby the check valve is opened by the diaphragm when air pressure within said earloop facemask is positive, allowing air flowing through.

In addition, the cover has a rough bottom surface for fixed disposition on said earloop facemask. The body further includes a bottom section abutting an inner side of the earloop facemask.

With structures disclosed above, the present invention performs discharge with better efficiency. When the diaphragm closes the area, the structure discharges breathed air within the earloop facemask only and reduces contact to outside air and the possibilities of contamination by polluted air. Moreover, with the rotation structure, the discharger structure is able to block out potential contaminants in the rains and in the air and smoothly discharge breathed air in accordance with different angle of disposition.

### BRIEF DESCRIPTION OF THE DRAWINGS

FIG. 1 is a perspective view of the present invention;

FIG. 2 is a front elevation view of the present invention;

FIG. 3A is a sectional view taken along line 3A-3A of FIG. 2;

FIG. 3B is a sectional view of a discharger structure of the present invention illustrating a diaphragm thereof closed;

FIG. 4 is another front elevation view showing discharging holes thereof in a first position;

FIG. 5 is an application example of the present invention;

FIG. 6 is a schematic diagram of the present invention in a preferred embodiment; and

FIG. 7 is a schematic diagram of the present invention in another preferred embodiment.

### DETAILED DESCRIPTION OF THE PREFERRED EMBODIMENT

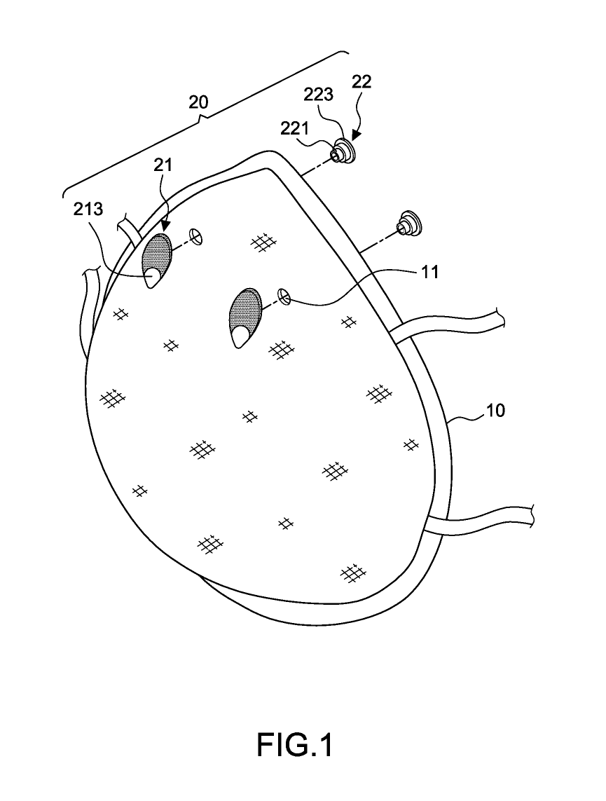

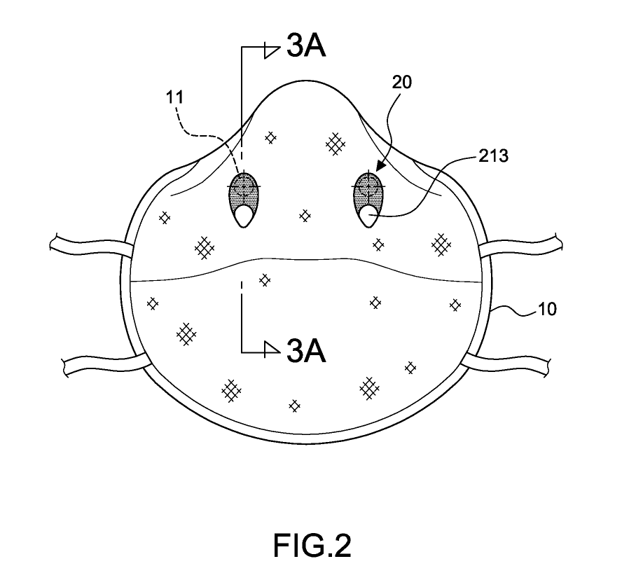

Referring to FIGS. 1-7, in a preferred embodiment, the present invention mainly comprises an earloop facemask 10, at least one discharger structure 20, and a rotation structure 40.

The earloop facemask 10 has a least one opening hole 11 at a position near nostrils of human faces when worn on. The discharger structure 20 includes a cover 21, a check valve 22, and a discharging hole 213.

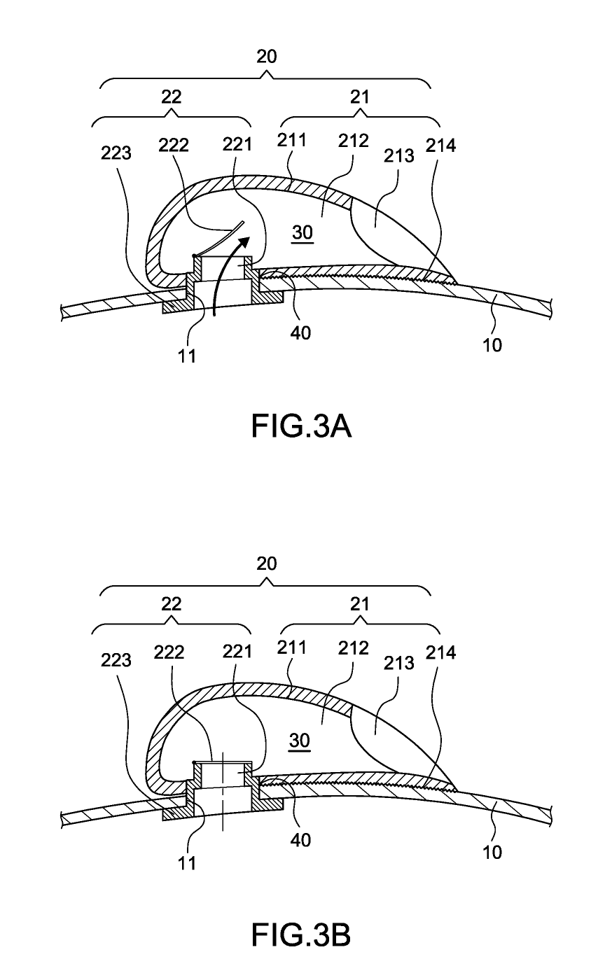

The cover 21 is arranged in a streamline shape and covers the opening hole 11 from outside; it further includes a passage space 212 therein. The check valve 22 is disposed on the opening hole 11. As shown in FIGS. 3A and 3B, in this embodiment, the check valve 22 includes a body 221, a diaphragm 222, and a bottom section 223. The body 221 protrudes from the opening hole 11 into the passage space 212 and the diaphragm 222 is disposed on a top periphery of the body 221 and is partially fixed thereon. The bottom section 223 abuts an inner side of the earloop facemask for fixing the check valve 22. Furthermore, the cover 21 has a rough bottom surface 214 for fixed disposition on the earloop facemask 10, preventing itself from slippery. The discharging hole 213 is arranged on the cover 21 at an opposite end from the check valve 22, defining an area 30 in the passage space 212 between the check valve 22 and the discharging hole 213.

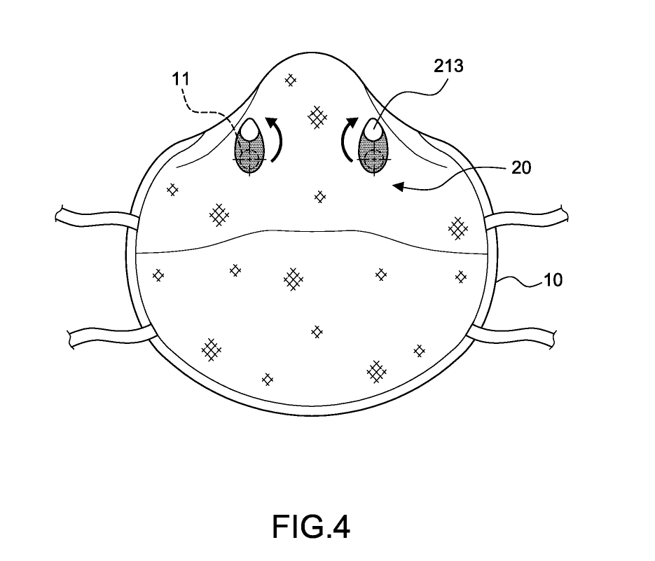

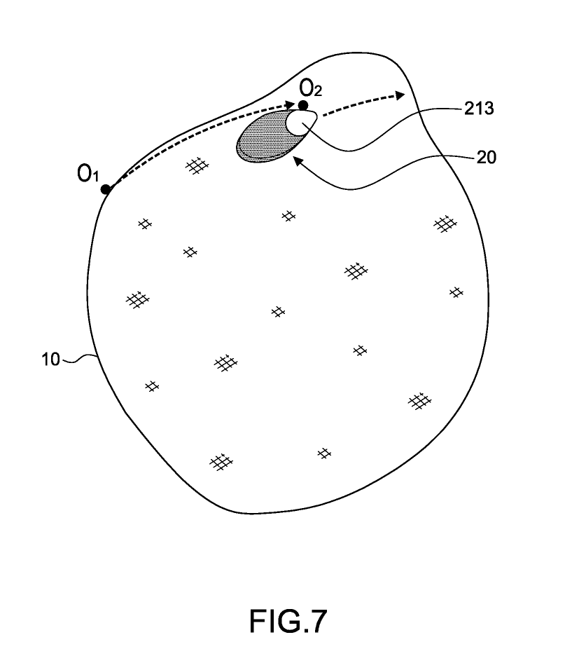

The rotation structure 40 is engaged on the check valve 22 for the cover 21 to rotate thereby. With reference to FIGS. 4 and 7, when external air pressure outside the facemask 10 is greater than internal air pressure within the facemask 10 under situations such as running and riding bikes or motorbikes, the discharging hole 213 can be rotated in a first position facing upwards by the rotation structure 40 for air discharge. According to Bernoulli's equation, the air pressure at a point 2 O₂ on a surface of the facemask 10 is less than the one at a point 1 O₁ at the peak of the facemask 10. The diaphragm 222 is affected by the pressure difference and an upward force produced thereby. Then it opens the check valve 22 and allows breathed air inside the facemask 10 to be discharged from the discharging hole 214. Thereby the internal air pressure is lessened and the amount of CO₂ is reduced, providing a comfortable experience for those wearing the facemask 10 and increasing people's willingness in wearing, thus achieving better efficiency in preventing harms from polluted air.

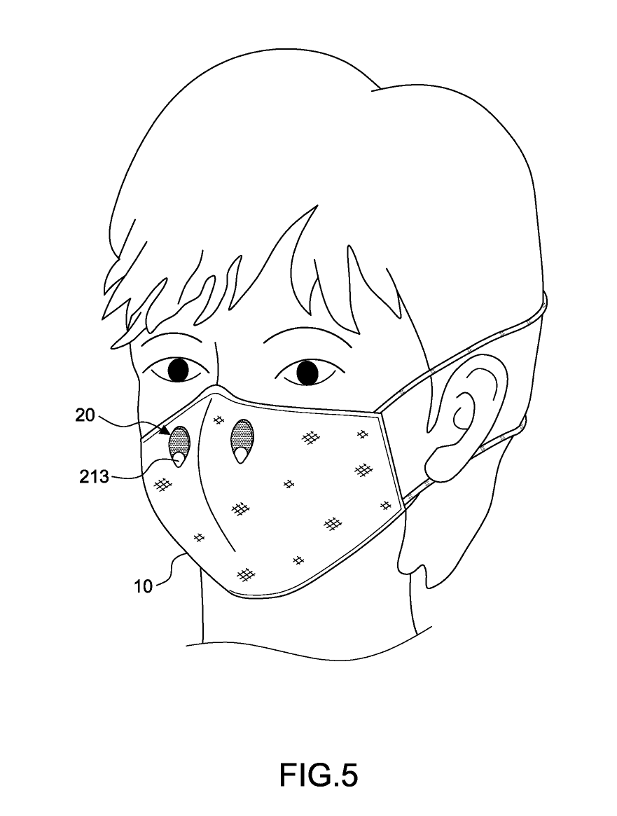

As shown in FIG. 5, the discharger structure 20 is rotatable. Under normal circumstances, the discharging hole 213 is facing downward for blocking out potential contaminants in the rains and in the air. When there is pressure difference as described above, the discharger structure 20 is rotated for the discharging hole 213 to face upward, so that breathed air is smoothly discharged therefrom.

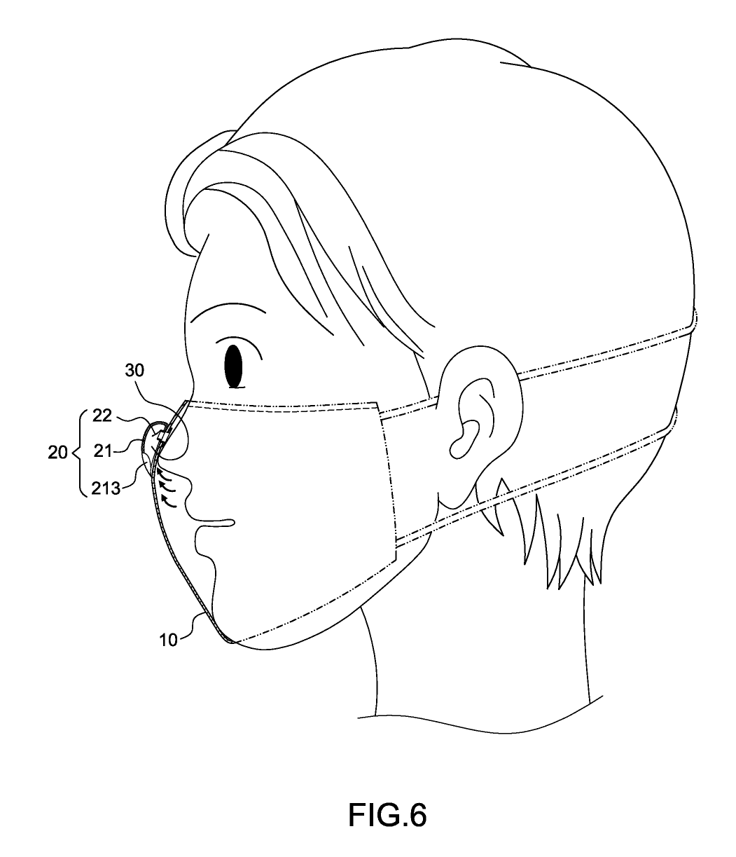

Another preferred embodiment is illustrated in FIG. 6, showing the present invention in application. When the earloop facemask 10 is being worn, a pressure difference would be produced by breathing. A negative pressure is produced by inhalation and air would enter the facemask 10; the check valve 22 is closed thereby. When breathed air is exhaled, a positive pressure is produced within the facemask 10 and the breathed air is discharged therefrom; the check valve 22 is opened thereby. On the other hand, with the design of the area 30 and the arrangement of the discharger structure 20 being near a position of human nostrils on human faces when worn on, the diaphragm 222 ensures less contact to outside air and less possibilities of contamination by polluted air.

As stated above, the discharger structure 20 and the rotation structure 40 allow the check valve 20 on the earloop facemask 10 to function conveniently and smoothly, so as to provide a comfortable experience for its users.

Although particular embodiments of the invention have been described in detail for purposes of illustration, various modifications and enhancements may be made without departing from the spirit and scope of the invention. Accordingly, the invention is not to be limited except by the appended claims.

What is claimed is:

1. A discharger structure on earloop facemasks, comprising:
an earloop facemask having a least one opening hole at a position near nostril of human faces when worn on;
at least one discharger structure including:
a cover arranged in a streamline shape covering said opening hole from outside, said cover including a passage space therein;
a check valve disposed on said opening hole, said check valve including a body protruding from said opening hole into said passage space and a diaphragm disposed on a top periphery of said body and partially fixed thereon;
a discharging hole arranged on said cover at an opposite end from said check valve, defining an area in said passage space between said check valve and said discharging hole; and
a rotation structure engaged on said check valve for said cover to rotate thereby;
whereby the check valve is closed by the diaphragm when air pressure within said earloop facemask is negative, preventing from airflow therein; and
whereby the check valve is opened by the diaphragm when air pressure within said earloop facemask is positive, allowing air flowing through.

2. The discharger structure on earloop facemasks as claimed in claim 1, wherein said cover has a rough bottom surface for fixed disposition on said earloop facemask.

3. The discharger structure on earloop facemasks as claimed in claim 1, wherein said body further includes a bottom section abutting an inner side of said earloop facemask.
